(19) United States
(12) Patent Application Publication
(10) Pub. No.: US 2012/0186526 A1
(43) Pub. Date: Jul. 26, 2012

(54) ANIMAL FEEDING DEVICE

(75) Inventors: Mark D. Olson, Stratford, IA (US); Julie Johnson Olson, Stratford, IA (US)

(73) Assignee: POWER TO THE HOOF, LLC, Stratford, IA (US)

(21) Appl. No.: 13/014,165

(22) Filed: Jan. 26, 2011

(51) Int. Cl. A01K 5/01

(52) U.S. Cl. 119/61.3

(57) ABSTRACT

The present invention is a feeder for feeding animals such as horses. The feeder generally comprises a feeding container adapted to receive animal feed such as hay. A restriction grate rests on top of feed. The grate comprises a plurality of openings through which the animal can access and eat the feed. The grate floats on top of the feed so that as the animals remove feed from the feeder through the openings in the grate, the grate moves downward in the feeder with the diminishing level of feed.

This application is based upon and claims priority to U.S. Provisional Application Ser. No. 61/198,361 filed Jan. 26, 2010, the complete disclosure of which is hereby expressly incorporated by this reference.

### BACKGROUND

The present invention relates to a feeder for feeding livestock, particularly horses. Unlike cows and other ruminant animals, a horse has very little feed storage capacity within its stomach. Cows and other animals may consume and store a large amount of food at one time then digest that same food for nourishment throughout the day. However, horses, which have evolved as grazing animals, should eat small, controlled amounts of food capable of being fully digested and processed within the stomach and digestive tract. Accordingly, horses are best suited to eat relatively small amounts of food continuously throughout the day. With a feeding regimen such as this, the overall health of the horse is favorably impacted.

### SUMMARY

The present invention is a feeder for feeding animals such as horses. The feeder generally comprises a feed container adapted to receive animal feed such as hay. A restriction grate rests within the feed container and is positioned over the top of feed. The grate comprises a plurality of controlled openings through which the animal can access and eat the feed. The grate floats on top of the feed so that as the animals remove feed from the feeder through the openings in the grate, the grate moves downward in the feeder with the diminishing level of feed.

### BRIEF DESCRIPTION OF THE DRAWINGS

FIG. 1 is a perspective view of the feeder;

FIG. 2 is a top view of the feeder;

FIG. 3 is a perspective view of the bottom of the feeder showing an embodiment having a floor section that opens;

FIG. 4 is a top view of the restriction grate;

FIG. 5 is a side view of the feeder;

FIG. 6 is a perspective view of an embodiment having interlocking walls which allow the device to be easily disassembled for storage and transportation;

FIG. 7 is a perspective view of an embodiment wherein the container is generally oval shaped; and

FIG. 8 is a top view of an alternate embodiment of the grate wherein the grate has support members which extend longitudinally along the grate.

### DETAILED DESCRIPTION

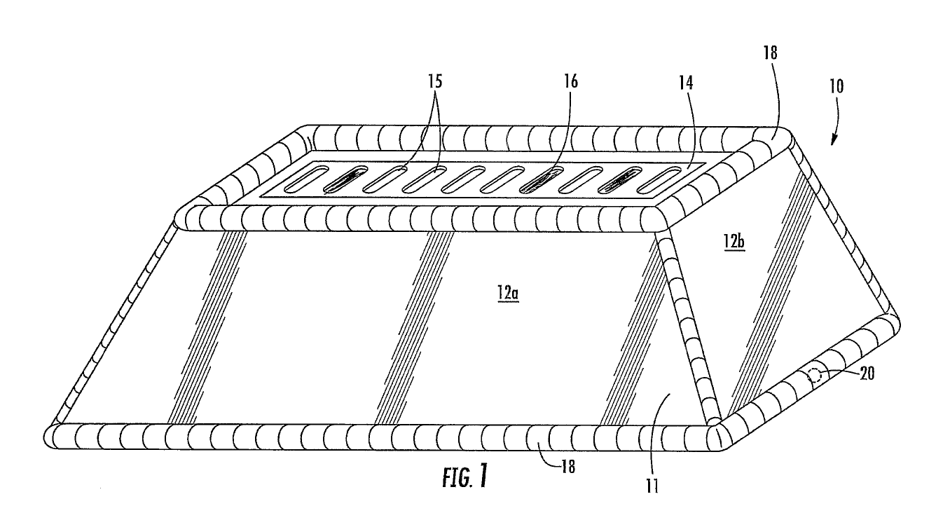

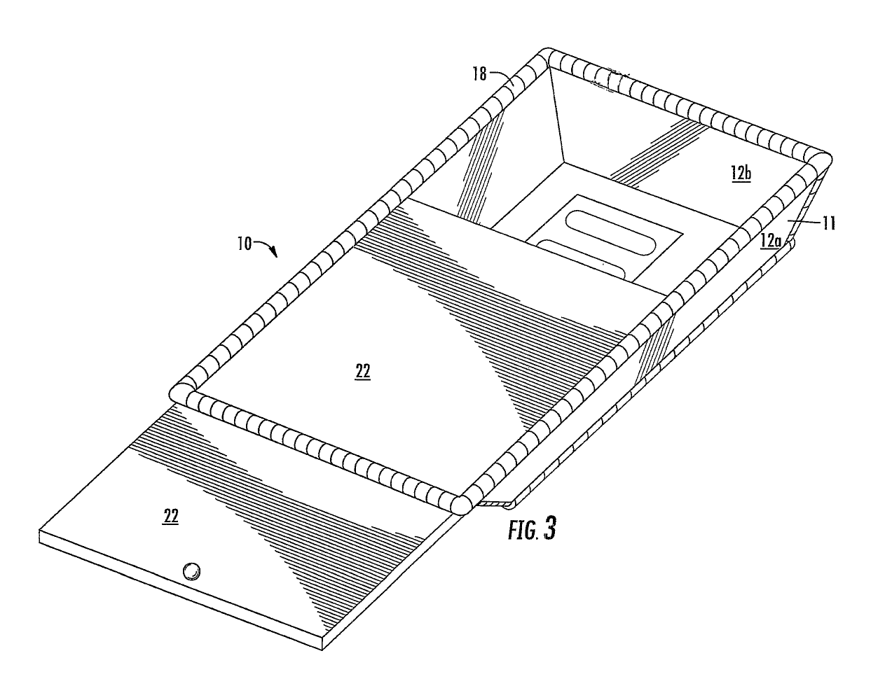

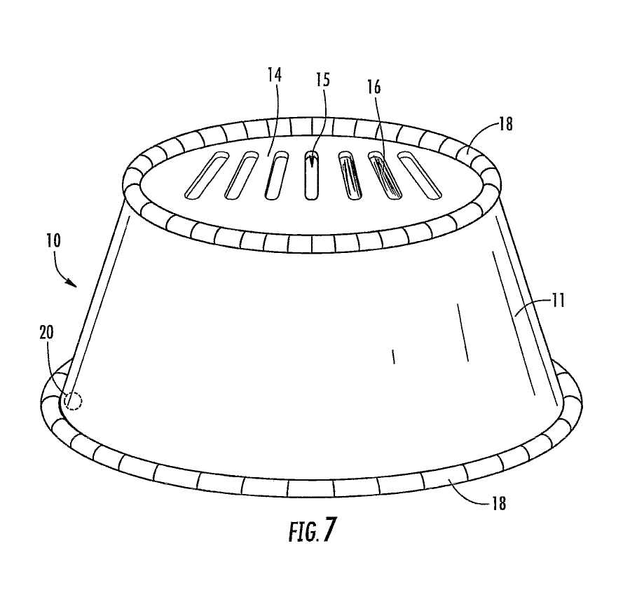

The present invention is a feeder 10 for feeding animals such as horses. As shown in FIGS. 1 and 3, the feeder 10 generally comprises a feed container 11 having a floor 22 with generally vertical walls extending upwardly therefrom and an opening in its top. The feed container 11 is adapted to receive animal feed 16 such as a hay bale. The floor of the feed container 11 may be any suitable shape including square, rectangular (FIG. 3), circular, and oval (FIG. 7). Although the invention may be any suitable shape, it will be described herein with reference to a preferred embodiment wherein the container 11 has a rectangular floor 22 with two side walls 12a and two end walls 12b extending generally upwardly therefrom. Regardless of the shape, the generally vertical walls of the preferred embodiment are tapered inwardly from the floor 22 up so as to help prevent cuts, scrapes or other injury to the grazing animal. In one embodiment, the opening in the top is large enough to allow two horses to feed from the feeder 10 at one time. The feeder walls 12a, 12b and floor 22 are preferably made from a durable material such as polyethylene or fiberglass which provides a combination of weather resistance, lighter weight and reasonable cost.

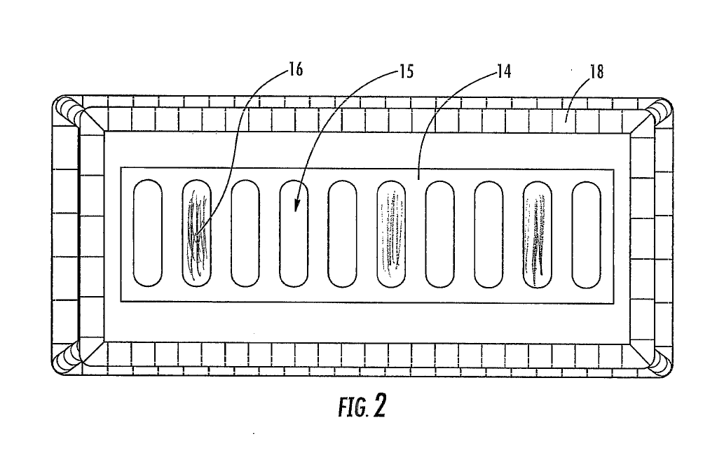

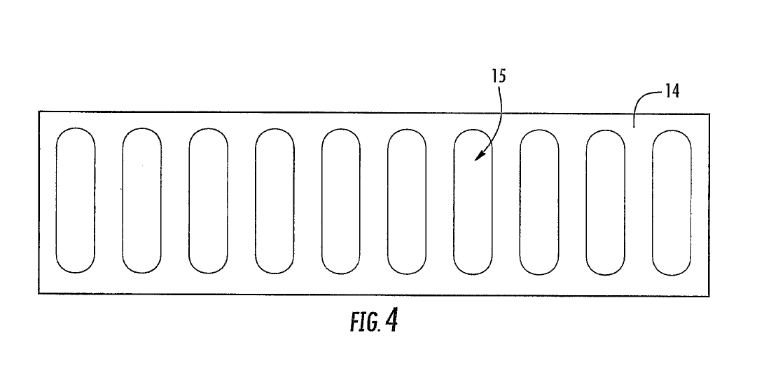

A restriction grate 14 is adapted to rest on top of feed 16 in the feed container 11. The restriction grate 14 is best seen in FIGS. 1, 2, and 4. The grate 14 is preferably made of polyethylene or fiberglass to provide durability and easy cleaning. The edges of the grate 14 are preferably rolled to further reduce the possibility of the feeding horses cutting or otherwise injuring themselves on sharp edges. In one embodiment, the length and width of the grate 14 is such that it is slightly smaller than the opening in the top of the feed container 11 so that the grate 14 can be easily inserted and removed from the opening in the top of the feed container 11. In another embodiment, the length and width of the grate 14 is such that it is slightly larger than the opening in the top of the feed container 11 so that it is retained within the interior of the feed container 11 when the feeder 10 is turned upside down. As is described below, this is beneficial in embodiments wherein the feed container 11 is turned upside down for insertion of feed through an opening in the bottom of the container 11. The grate 14 comprises a plurality of openings 15 through which an animal can access and eat the feed 16. The openings 15 are large enough to allow access to the feed. Based upon testing and analysis, however, the openings 15 are of such a size so as to prevent the animal from eating too quickly or otherwise gorging itself.

The openings 15 are sized and shaped to allow the animal to have only one mouthful of feed 16 at a time. In one embodiment, the openings are an oblong shape such as an oval or a rectangle. The elongated dimension of the oblong shape can be oriented along the length or width of the grate 14. In one embodiment suitable for average sized adult horses, the openings 15 are oval shaped and about eighteen inches long, about three inches wide, and spaced about two inches apart. In another embodiment suitable for draft horses, the openings 15 are oval shaped and about eighteen inches long and about four and a quarter inches wide. Other embodiments use different sized openings 15 that are optimal for different sized horses. The number of openings 15 may vary depending on the size of the feed container 11. The grate 14 floats on top of the feed 16 so that as the animal removes feed 16, the grate 14 moves downward in the feed container 11 with the diminishing level of feed 16. In addition to regulating the rate at which the horses eat, the grate 14 also helps to prevent waste by preventing the feed 16 from blowing out of the feeder 10 and by preventing the horses from pulling out overly large amounts of feed 16 which falls to the ground and becomes contaminated.

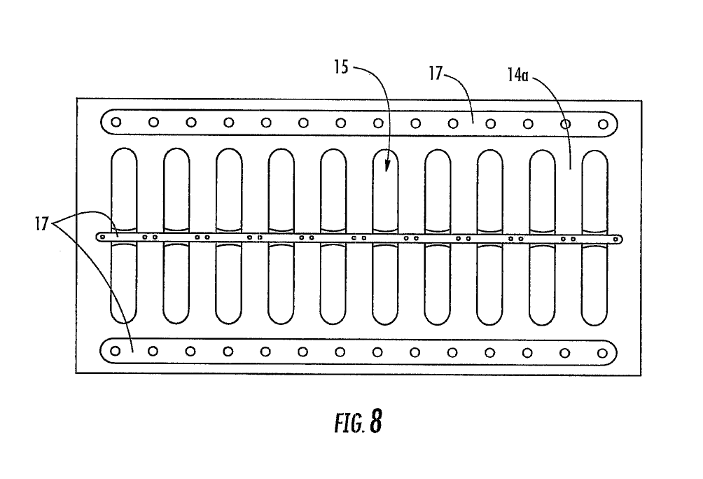

FIG. 8 shows an alternate embodiment of a grate 14a having support members 17 that extends longitudinally along the grate 14a to add support and rigidity. As shown, this embodiment may include a support member 17 that extends along the middle of the device thereby making the openings 15 smaller. Smaller openings 15 reduce the likelihood that a horse will get its hoof caught in the grate 14a.

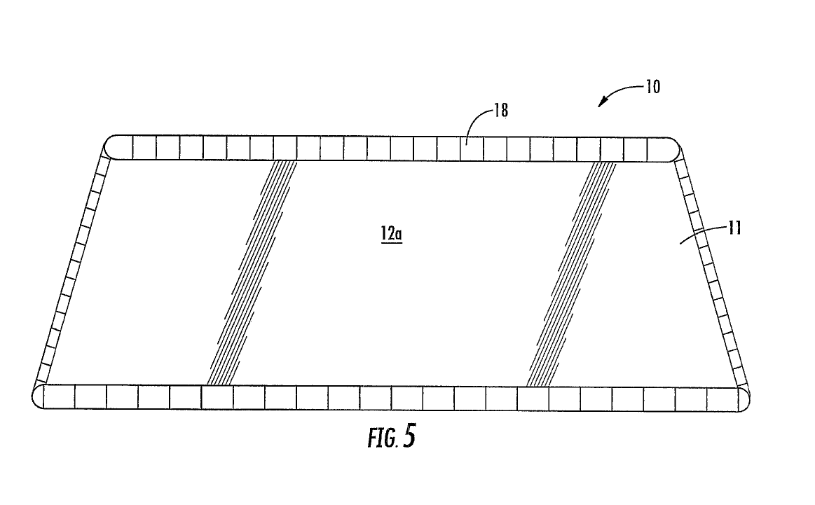

As shown in FIGS. 1 and 5, some embodiments of the feeder 10 comprise rolled or rounded edges 18. The rounded edges 18 are preferably located around the opening in the top of the feed container 11 and around the base of the feed container 11 as shown in FIG. 1. The rounded edges 18 may be integrally combined with the container 11 so that the rounded edges are part of the container 11 (e.g. part of the walls 12a, 12b). Alternatively, the rounded edges 18 may be removable from the container 11 such that they can be replaced if they become damaged or worn out. In the embodiments where the rounded edges 18 are removable from the container 11, the rounded edges 18 may be removably combined with the container 11 using fasteners such as screws, by a physical connection means such as a tongue and groove joint, or by any other suitable means.

In some embodiments, rounded edges 18 may be used on other parts of the feed container 11 such as the corners adjoining adjacent walls 12a, 12b. The rounded edges 18 provide added safety for the animals as they eat from the feeder 10. The rounded edges 18 along the base helps to prevent the animals from getting its hoof caught. The rounded edges 18 along the top opening and other edges of the feed container 11 help to prevent the animals from cutting their legs or body. Further, the rounded edges 18 help to prevent cribbing because they are difficult for the horse to bite.

As shown in FIGS. 1 and 5, in some embodiments one or more of the side walls 12a and end walls 12b are angle outward so that the feed container 11 is wider at the bottom than at the top. This helps to provide stability which helps to prevent a horse from knocking the feeder 10 over. In addition, this shape serves as a safety feature to help prevent the horse from rubbing or cutting its legs on the top portion of the feed container 11 as it eats. In one embodiment, the walls 12a, 12b are angle outward from top to bottom at an angle of about eighty degrees.

As shown in FIG. 1, some embodiments comprise one or more exit openings 20 near the bottom of the feed container 11. These openings 20 allow water and other liquids to drain out of the feeding container 11. This helps to prevent the feed 16 from spoiling if water or other liquids inadvertently enter into the feed container 11.

As shown in FIG. 3, some embodiments comprise a movable floor member 22. The movable floor member 22 is adapted to be selectively opened and closed. In its open position, an opening is created in the bottom of the feed container 11 to allow easy loading of feed 16 through the underside of the feeder 10. After the feed 16 is placed in the feeder 16, the floor member 22 is moved to its closed position and the feeder 10 is turned right-side up. In the embodiment shown in FIG. 3, the movable floor member 22 slides through a slotted opening in one of the end walls 12b of the feed container 11 to selectively open and close the opening. In other embodiments, the movable floor member 22 may slide through a side wall 12a or be pivotally combined with the feed container 11.

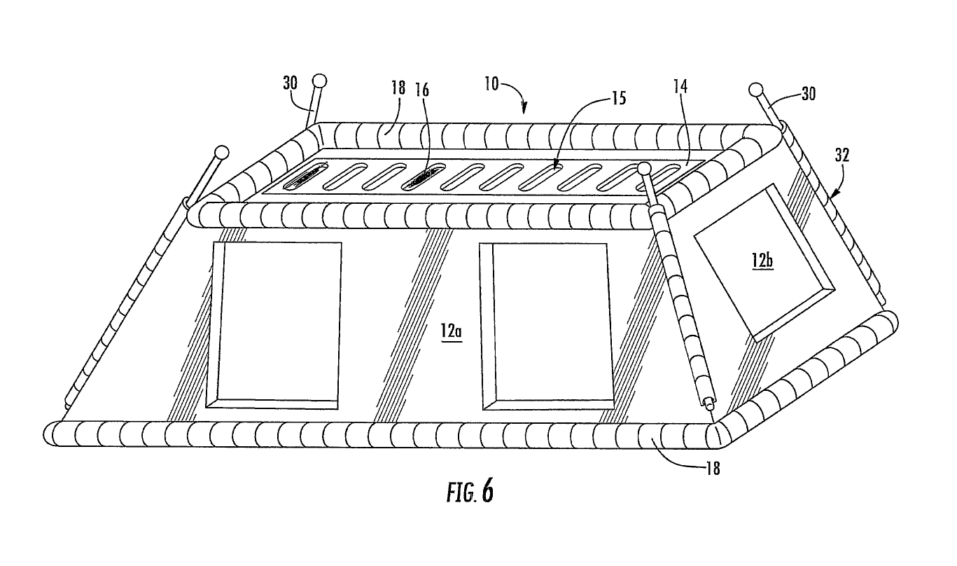

FIG. 6 shows an alternate embodiment wherein the feed container 11 can be easily disassembled for storage and transportation then reassembled for use. In this embodiment, the ends of the walls 12a, 12b have an opening adapted to receive a locking member 30 such as a pin, screw, or rebar. The rounded edges 18 may also have openings therein adapted to receive the locking member 30. The locking member 30 is inserted through the generally vertical openings in the walls 12a, 12b to help secure the walls 12a, 12b together to create the assembled feed container 11. The locking member 30 is easily removed to allow to walls 12a, 12b to be separated for disassembly of the container 11. As shown in FIG. 6, the ends of the walls 12a, 12b (i.e. the corners of the container 11) fit together in an interlocking or dovetail fashion as shown at reference number 32. It should be noted that the interlocking corners feature is not necessary as long as the locking member 30 adequately secures the walls 12a, 12b together.

For the embodiment shown in FIG. 6, the floor 22 may be similar to the sliding floor 22 shown in FIG. 3 and described above. Alternatively, the floor 22 may be fixed and secured in place by the interlocking walls 12a, 12b.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

1. A feeder adapted to receive animal feed for feeding an animal, said feeder comprising:
a container having a top end with an opening therein, a bottom end, a floor, and walls extending upwardly from the floor, each wall having a top end and a bottom end;
a restriction grate having a plurality of openings through which the animal can eat the feed, said restriction grate adapted to be placed in the container on top of the animal feed so that the grate floats downward in the container as the feed is eaten by the animal;
wherein each wall angles outward from its top end to its bottom end thereby making the container wider at its bottom end.

2. The feeder of claim 1 wherein the openings in the grate are oval shaped.

3. The feeder of claim 1 wherein the floor is oval shaped.

4. The feeder of claim 1 wherein the floor is selectively movable between a closed position and an open position to create an opening in the bottom end of the container when the floor is in its open position, said opening adapted to receive the animal feed.

5. The feeder of claim 1 wherein the restriction grate is rectangular having a length different from a width.

6. The feeder of claim 5 wherein the openings in the restriction grate are oblong and the elongated dimension of the oblong openings extend along the length of the restriction grate.

7. The feeder of claim 5 wherein the openings in the restriction grate are oblong and the elongated dimension of the oblong openings extend along the width of the restriction grate.

8. The feeder of claim 1 wherein the restriction grate is slightly larger than the opening in the top end of the container so that the restriction grate is retained in the container when the container is turned upside down.

9. A feeder adapted to receive animal feed for feeding an animal, said feeder comprising:
a container having a top end with an opening therein, a bottom end, and a floor with walls extending upwardly therefrom, each wall having a top end and a bottom end, wherein the floor is movable between an open position and a closed position to create an opening in the bottom end of the container when the floor is in its open position, said opening adapted to receive the animal feed;
a restriction grate having a plurality of openings through which the animal can eat the feed, said restriction grate adapted to be placed in the container on top of the animal feed so that the grate floats downward in the container as the feed is eaten by the animal; and
a rounded member near the top end and bottom end of each wall to help protect the animal as its feeds.

10. The feeder of claim 9 wherein the openings in the grate are oval shaped.

11. The feeder of claim 9 wherein the restriction grate is rectangular having a length different from a width.

12. The feeder of claim 11 wherein the openings in the restriction grate are oblong and the elongated dimension of the oblong openings extend along the length of the restriction grate.

13. The feeder of claim 11 wherein the openings in the restriction grate are oblong and the elongated dimension of the oblong openings extend along the width of the restriction grate.

14. The feeder of claim 9 wherein the restriction grate is slightly larger than the opening in the top end of the container so that the restriction grate is retained in the container when the container is turned upside down.

15. A collapsible feeder for feeding an animal having an erect configuration and a disassembled configuration, wherein the feeder is adapted to receive feed in its erect configuration, said feeder comprising:
a container having a top end with an opening therein, a floor, two opposing end walls, and two opposing side walls, each wall having two ends, each end having a generally vertical opening therein;
wherein the ends of each side wall are adapted to interlock with the ends of each end wall to create the container in its erect configuration;
an elongated locking member adapted to be inserted into the generally vertical openings in the end of each wall to help secure the side walls to the end walls when the feeder is in its erect configuration;
a restriction grate having a plurality of openings through which the animal can eat the feed, said restriction grate adapted to be placed in the on top of the animal feed so that the grate floats downward in the container as the feed is eaten by the animal when the container is in its erect configuration.

16. The feeder of claim 15 wherein each wall angles outward from its top end to its bottom end thereby making the container wider at its bottom end.

17. The feeder of claim 15 wherein the top end and bottom end of each wall is rounded to help protect the animal as its feeds.

18. The feeder of claim 15 wherein the openings in the grate are oval shaped.

19. The feeder of claim 15 wherein the restriction grate is rectangular having a length different from a width.

20. The feeder of claim 19 wherein the openings in the restriction grate are oblong and the elongated dimension of the oblong openings extend along the length of the restriction grate.

21. The feeder of claim 19 wherein the openings in the restriction grate are oblong and the elongated dimension of the oblong openings extend along the width of the restriction grate.

22. The feeder of claim 15 wherein the floor is movable between an open position and a closed position to create an opening in the bottom end of the container when the floor is in its open position, said opening adapted to receive the animal feed.

23. The feeder of claim 15 wherein the restriction grate is slightly larger than the opening in the top end of the container so that the restriction grate is retained in the container when the container is turned upside down.

24. The feeder of claim 15 wherein the grate further comprises a support member which extends longitudinally along the grate bisecting the restriction grate's openings.
